(19) United States
(12) Patent Application Publication
(10) Pub. No.: US 2024/0167824 A1
(43) Pub. Date: May 23, 2024

(54) METHOD FOR THE LOCALIZATION OF A NETWORKED MOTOR VEHICLE

(71) Applicant: Robert Bosch GmbH, Stuttgart (DE)

(72) Inventors: Michael Gabb, Gaeufelden (DE); Stefan Nordbruch, Leonberg (DE)

(21) Appl. No.: 18/496,260

(22) Filed: Oct. 27, 2023

(30) Foreign Application Priority Data
Nov. 17, 2022 (DE) 10 2022 212 249.6

(51) Int. Cl. G01C 21/30

(52) U.S. Cl. CPC G01C 21/30; B60W 60/00

(57) ABSTRACT

A method for the localization of a networked motor vehicle. The motor vehicle is designed to be driven in an at least semi-automated manner. The method includes: a first localization of the motor vehicle is carried out using on-board localization systems and first localization results are generated. In addition, external localization information is received by the motor vehicle from a source outside the vehicle, such as an infrastructure system. A second localization of the motor vehicle is then carried out using the received localization information. The received external localization information can include second localization results, or second localization results are generated from the received external localization information. The first localization is checked, in particular continuously, via the second localization, in particular by a comparison of the first and second localization results.

### CROSS REFERENCE

The present application claims the benefit under 35 U.S.C. § 119 of German Patent Application No. DE 10 2022 212 249.6 filed on Nov. 17, 2022, which is expressly incorporated herein by reference in its entirety.

### FIELD

The present invention relates to a method for the localization of a networked motor vehicle, which is designed in particular to be driven in an at least semi-automated manner. The present invention further relates to a device for driving assistance of a networked motor vehicle. The present invention further relates to a motor vehicle.

### BACKGROUND INFORMATION

Precise position determination is essential for the navigation of vehicles and for automated driving functions of vehicles. Usually, data from a global navigation satellite system or GNSS are used for determining the position of the vehicle. Such GNSS data are provided, for example, by satellites. A position sensor, such as a GPS sensor, can receive the GNSS data and calculate a position of the vehicle therefrom.

To receive GNSS data from the satellites, an unobstructed path between the position sensor and the satellites is usually necessary. Vegetation and buildings can thus impair the reception of the GNSS data and the precision of position determination. Furthermore, correction data are necessary for highly accurate positioning.

German Patent Application No. DE 10 2016 006 137 A1 describes a method for the localization of a vehicle.

German Patent Application No. DE 10 2020 125 448 A1 describes a method for determining the position of at least one road user that is to be localized.

German Patent Application No. DE 10 2017 130 624 A1 describes a vehicle position determination system with the use of V2X, sensor and GNSS information.

Furthermore, a localization on the basis of dynamic objects is described in German Patent Application No. DE 10 2018 220 782 A1.

As in other fields of technology, networking is playing an increasingly important role in vehicle applications. More and more vehicles have the possibility of connecting within a cloud to other road users, to infrastructure components (e.g. so-called roadside units) or to backend services.

### SUMMARY

An object of the present invention to provide a method and a device which enable reliable localization of a networked motor vehicle.

This object may be achieved by means of the subject matter of the present invention. Advantageous embodiments of the present invention are disclosed herein.

According to a first aspect of the present invention, a method for the localization of a networked motor vehicle is provided, wherein the motor vehicle is in particular designed to be driven in an at least semi-automated manner. According to an example embodiment of the present invention, the method comprises at least the following steps:

A first localization of the motor vehicle is carried out by means of on-board localization systems and first localization results are generated.

In addition, external localization information is received by the motor vehicle from a source outside the vehicle, such as an infrastructure system. A second localization of the motor vehicle is then carried out by means of the received localization information. In this case, the received external localization information can include second localization results, or second localization results are generated from the received external localization information.

The first localization is checked, in particular continuously, via the second localization, in particular by means of a comparison of the first and second localization results.

The first localization can be carried out, for example, on the basis of data from a global navigation satellite system and/or by means of an environment model and/or on the basis of environment-related information from a vehicle sensor system.

For example, data from an infrastructure system that were generated by means of stationary sensors of the infrastructure system can be requested for the second localization.

For example, data or data sets that enable the motor vehicle to be assigned a position within a local or global coordinate system can be understood here as localization results. The coordinates may be relative or absolute. The localization results can, for example, indicate a position and location of the motor vehicle relative to a piece of infrastructure and/or in a map.

According to an example embodiment of the present invention, the external localization information received may, for example, already explicitly include second localization results, i.e., a position and location of the motor vehicle relative to a piece of infrastructure and/or in a map, wherein these second localization results were generated by a localization system external to the vehicle, for example by an environment sensor system of the infrastructure system. Alternatively or additionally, the external localization information may comprise information, for example, about the position relative to other objects, from which information a computing unit of the motor vehicle can generate second localization results.

According to an example embodiment of the present invention, the motor vehicle has a plurality of on-board localization sources which are comprised by the on-board localization system and which are independent of one another. For example, a first on-board localization source is based on one or more global satellite navigation systems (GNSS). For example, a second on-board localization source is based on so-called feature-based localization methods. In a preferred embodiment of the present invention, one or more faulty localization sources of the on-board localization system and/or of the external infrastructure system are identified depending on the result of the check. In a particularly preferred embodiment of the present invention, individual localization sources of the on-board localization system that have been identified as faulty can be compensated for by fault-free localization sources of the external infrastructure system. This can in particular be understood to mean that individual on-board localization sources are temporarily not used for the localization of the motor vehicle and information (localization information or localization results) from the external infrastructure system is used instead for the localization of the motor vehicle. The availability and the accuracy of localization is thus improved. Faulty sources, for example, are not used for localization and safety is increased. Furthermore, a degradation of the motor vehicle due to individual or several faulty or failed localization sources can be avoided.

In a preferred embodiment of the present invention, the motor vehicle alternatively or additionally receives information about an imminent failure of certain localization sources from the external infrastructure system and/or from another external source and/or receives such information from an on-board source.

The present invention thus may permit proactive switching/connection of localization sources of the infrastructure if, for example, it is known in advance that one or more localization sources/systems will not be available. The information about such an imminent failure of a localization source can be obtained, for example, via a map, empirical values from the past, information from other vehicles, etc. Examples of such imminent failures are the loss of satellite reception in tunnels or urban canyons, leading to a GNSS-based on-board localization source being temporarily unavailable.

According to an example embodiment of the present invention, optionally or additionally, the availability of a reliable localization can be proactively increased if it is already known in advance when and where one of the in-vehicle localization sources will not be available. This information can come from an external source (outside the vehicle) or from a source within the vehicle or also as a combination of both sources. Possible external information sources are, for example, telematics services and fleet data or V2X information from other vehicles driving ahead of the motor vehicle. Possible on-board information sources are, for example, previous trips of the vehicle on the same route, wherein the loss and status of the on-board localization sources is logged and read out again, and/or information from a digital map of the vehicle which contains static information about the available localization sources.

According to an example embodiment of the present invention, for the check, a distance of the motor vehicle from a specific point can preferably be calculated in each case as first and second localization results, and a difference of the first and second localization results can be formed. This difference can be compared with a threshold value. If, for example, the difference exceeds a certain threshold value, a faulty localization source must be assumed.

The check can thus be carried out particularly quickly and efficiently.

According to an example embodiment of the present invention, alternatively or additionally, for the check a comparative value of the first and second localization results can be observed over a certain time, and a check of the first localization can be made by carrying out a sequential statistical test, in particular a “sequential probability ratio” test and/or a “Kolmogorov-Smirnov” test.

The check can thus be carried out particularly precisely, with statistical outliers thereby being eliminated.

According to an example embodiment of the present invention, alternatively or additionally, for the check an uncertainty and/or a confidence regarding positions determined as first and second localization results can be calculated. In particular, an uncertainty and/or a confidence can be determined by performing a chi-square goodness-of-fit test to statistically test for equality of second Gaussian distributions.

The result of the check according to the present invention is a more reliable and more robust localization of the motor vehicle. As it is backed up and checked by an additional source, this can offer an increased safety level (e.g. ASIL).

According to a further aspect of the present invention, a device for the localization of a networked motor vehicle is provided, wherein the motor vehicle is in particular designed to be driven in an at least semi-automated manner. The device is designed to carry out a method according to the first aspect. According to an example embodiment of the present invention, the device comprises a communication unit and at least one computing unit. The communication unit is designed to receive external localization information from an external infrastructure system. The computing unit is designed to carry out a first localization of the motor vehicle by means of data from on-board localization systems and to generate first localization results. The computing unit is further designed to carry out a second localization of the motor vehicle by means of the received external localization information, wherein second localization results are either included in the external localization information or are generated therefrom.

According to an example embodiment of the present invention, the computing unit is further designed to continuously check the first localization results via the second localization results, in particular by means of a comparison of the first and second localization results, and to output the result of the check.

According to an example embodiment of the present invention, the device is preferably designed as a control device for a motor vehicle driven in an at least semi-automated manner. The computing unit and the communication unit can be integrated in two separate control devices or in a common control device.

According to a third aspect of the present invention, a networked motor vehicle is provided, which is in particular designed to be driven in an at least semi-automated manner, and which comprises a device according to the second aspect.

The wording “networked motor vehicle” covers a motor vehicle which has a suitable communication device with which the networked motor vehicle can exchange data with other road users, in particular with an infrastructure system. For this purpose, a wireless data connection is established, via which the networked motor vehicle can transmit and/or receive data. It can preferably be a radio connection, for example a mobile radio connection or a direct wireless connection. Such communication between a motor vehicle and another road user is also referred to as V2X or C2X communication.

The wording “at least semi-automated” covers one or more of the following case: assisted driving, semi-automated driving, highly automated driving, and fully automated driving of a motor vehicle.

Assisted driving means that a driver of the motor vehicle permanently performs either the lateral or longitudinal control of the motor vehicle. The other driving task in question (i.e. control of the longitudinal or lateral control of the motor vehicle) is carried out automatically. This therefore means that, in the case of assisted driving of the motor vehicle, either the lateral or longitudinal control is controlled automatically.

Semi-automated driving means that, in a specific situation (for example: driving on a freeway, driving within a parking lot, overtaking an object, driving within a lane defined by lane markings), and/or for a certain period of time, longitudinal and lateral control of the motor vehicle are automatically controlled. A driver of the motor vehicle does not have to manually control the longitudinal and lateral control of the motor vehicle himself. However, the driver must permanently monitor the automatic control of the longitudinal and lateral control in order to be able to intervene manually if necessary. The driver must be prepared to fully take over the motor vehicle at any time.

Highly automated driving means that, for a certain period of time in a specific situation (for example: driving on a freeway, driving within a parking lot, overtaking an object, driving within a lane defined by lane markings), longitudinal and lateral control of the motor vehicle are controlled automatically. A driver of the motor vehicle does not have to manually control the longitudinal and lateral control of the motor vehicle himself. The driver does not need to permanently monitor the automatic control of the longitudinal and lateral control in order to be able to intervene manually if necessary. If required, a take-over request is automatically output to the driver for taking over the control of the longitudinal and lateral control, and in particular is output with a sufficient time reserve. The driver therefore potentially has to be able to take over control of the longitudinal and lateral control. Limits of the automatic control of the longitudinal and lateral control are detected automatically. In highly automated driving, it is not possible to automatically bring about a state of minimum risk in every initial situation.

Fully automated driving means that, in a specific situation (for example: driving on a freeway, driving within a parking lot, overtaking an object, driving within a lane defined by lane markings), longitudinal and lateral control of the motor vehicle are controlled automatically. A driver of the motor vehicle does not have to manually control the longitudinal and lateral control of the motor vehicle himself. The driver does not need to monitor the automatic control of the longitudinal and lateral control in order to be able to intervene manually if necessary. Before the automatic control of the longitudinal and lateral control is terminated, the driver is automatically prompted to take over the driving task (controlling the longitudinal and lateral control of the motor vehicle), in particular with a sufficient time reserve. If the driver does not take over the driving task, there will be an automatic return to a state of minimum risk. Limits of the automatic control of the longitudinal and lateral control are detected automatically. In all situations, it is possible to return automatically to a system state of minimum risk.

Driverless control or driving means that, independently of a specific application case (for example: driving on a freeway, driving within a parking lot, overtaking an object, driving within a lane defined by lane markings), longitudinal and lateral control of the motor vehicle are controlled automatically. A driver of the motor vehicle does not have to manually control the longitudinal and lateral control of the motor vehicle himself. The driver does not need to monitor the automatic control of the longitudinal and lateral control in order to be able to intervene manually if necessary. The longitudinal and lateral control of the vehicle is thus controlled automatically, for example, for all road types, speed ranges and environmental conditions. The entire driving task of the driver is thus taken over automatically. The driver is therefore no longer required. The motor vehicle can thus drive even without a driver from any starting position to any desired destination position. Potential problems are solved automatically, i.e. without the help of the driver.

Remote control of the motor vehicle means that longitudinal and lateral control of the motor vehicle is controlled remotely. This means, for example, that remote control signals are sent to the motor vehicle for remotely controlling the lateral and longitudinal control. Remote control is carried out, for example, by means of a remote control device.

The present invention accordingly enables in-vehicle localization to be supported by an intelligent infrastructure. This results in an increase in robustness, fail-safety, reliability, accuracy and safety, by virtue of localization being checked continuously and inaccurate or insufficient or failing or faulty position sources (for example, GPS, but also feature-based localizations) being detected and compensated for. In this context, compensation can mean in particular that, at least temporarily, individual on-board localization sources are replaced by vehicle-external localization information, or at least supported or the localization is corrected.

Localization errors and inconsistencies of an on-board localization can be reliably determined in this way. This results in an increase in safety and prevention of possible faults due to incorrect localization, in particular in the case of an at least semi-automated driving of the motor vehicle.

### BRIEF DESCRIPTION OF THE DRAWINGS

Example embodiments of the present invention are described in detail with reference to the figures.

FIG. 1 shows a flowchart of an exemplary embodiment of a method according to the present invention.

FIG. 2 shows a block diagram of a device according to an exemplary embodiment of the present invention.

### DETAILED DESCRIPTION OF EXAMPLE EMBODIMENTS

In the following description of the exemplary embodiments of the present invention, identical elements are denoted by the same reference signs, and repeated description of these elements may be omitted if necessary. The drawings show the subject matter of the present invention only schematically.

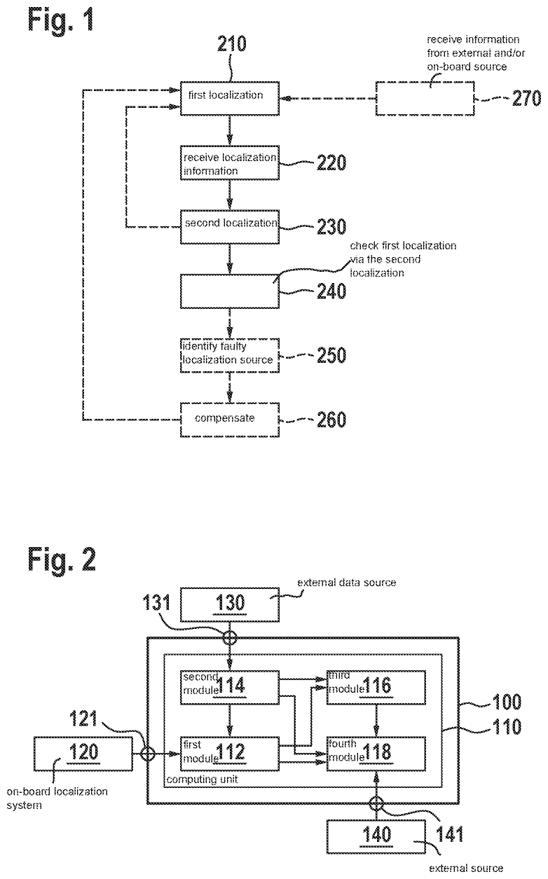

FIG. 1 shows by way of example the sequence of a method for the localization of a networked motor vehicle according to a possible exemplary embodiment of the present invention. The motor vehicle in this example is designed to be driven in an at least semi-automated manner.

In a first step 210, a first localization of the motor vehicle is carried out by means of on-board localization systems, and first localization results are generated. Optionally, the motor vehicle in this case receives information 270 from an external infrastructure system and/or from another external source and/or from an on-board source, said information concerning an imminent failure or an imminent limitation of certain localization sources of the on-board localization systems, and can use this information when generating the first localization results.

In a second step 220, localization information from an external infrastructure system is received by the motor vehicle.

In a third step 230, a second localization of the motor vehicle is carried out by means of the received localization information, and second localization results are generated.

Steps 210 to 230 are preferably carried out repeatedly during the movement of the motor vehicle, for example at regular time intervals.

In step 240, the first localization is checked continuously via the second localization, in particular by means of a comparison of the first and second localization results.

In an optional step 250, depending on the result of the check in step 240, one or more faulty localization sources of the on-board localization system and/or of the external infrastructure system are identified. A localization source of the on-board localization system is in particular to be understood here as one of a plurality of localization sources of the motor vehicle. For example, the motor vehicle has a first localization source based on a global satellite navigation system (GNSS) and a second (feature-based) localization source based on an environmental sensor system.

In a further optional step 260, the one or more localization sources of the on-board localization system that were identified as faulty in step 250 are compensated for by fault-free localization sources of the external infrastructure system; i.e. the information received in step 230 for localization of the networked motor vehicle is used in addition or exclusively, at least temporarily.

FIG. 2 shows a block diagram of a device 100 for the localization of a networked motor vehicle, in particular a control unit of the networked motor vehicle. The motor vehicle (not shown) which has the device 100 is designed to be driven in an at least semi-automated manner.

The device 100 comprises a computing unit 110, and communication interfaces 121, 131, 141, wherein the communication interfaces 121, 131, 141 are parts of a communication unit via which data from different on-board and vehicle-external sources 120, 130, 140 can be supplied to the computing unit 110.

The computing unit comprises a first module 112 which is designed to carry out a first localization of the motor vehicle by means of on-board localization systems 120 and to generate first localization results. For this purpose, the module 112 receives, via the communication interface 121, localization data from on-board localization systems, such as a GNSS module or a feature-based localization system.

The computing unit comprises a second module 114, which is designed to carry out a second localization of the motor vehicle by means of data which are received from an external data source 130, for example from an infrastructure system, via the communication interface 131, and to generate second localization results.

The first and second localization results are supplied to a third module 116 of the computing unit, where a consistency check, i.e. a check of the first localization via the second localization, is carried out by means of a comparison of the first and second localization results. By means of this mutual check, for example, faulty localization sources can be detected. A reliable and secure localization of the motor vehicle is thereby achieved.

The first and second localization results, as well as the result of the consistency check, are supplied to a third module 118 of the computing unit, where a compensation for the faulty or unavailable localization sources is carried out. In order to detect unavailable localization sources, the module 118 can receive, via the communication interface 141, information from a vehicle-external or on-board source 140 about an imminent or current failure of certain localization sources.

A robust and fail-safe localization of the motor vehicle is thereby achieved.

What is claimed is:

1. A method for a localization of a networked motor vehicle, which is configured to be driven in an at least semi-automated manner, the comprising the following steps:
carrying out a first localization of the motor vehicle using an on-board localization system and generating first localization results;
receiving, by the motor vehicle, external localization information from an external source including an external infrastructure system;
carrying out a second localization of the motor vehicle using the received external localization information; and
continuously checking the first localization via the second localization using a comparison of the first localization results with second localization results, wherein the second localization results are included in the external localization information or are generated from the external localization information.

2. The method according to claim 1, wherein the on-board localization system of the motor vehicle has at least two independent localization sources and wherein, depending on a result of the checking, one or more of the localization sources of the on-board localization system and/or of the external infrastructure system are identified as unavailable.

3. The method according to claim 2, wherein the localization sources of the on-board localization system that have been identified as unavailable are compensated for by fault-free localization sources of the external infrastructure system.

4. The method according to claim 1, wherein the motor vehicle receives information about an imminent failure of certain localization sources from the external infrastructure system and/or from another external source and/or from an on-board source.

5. The method according to claim 1, wherein, for the checking, a distance of the motor vehicle from a specific point is calculated in each case as the first and second localization results, and a difference in the first and second localization results is formed, and the difference is compared with a threshold value.

6. The method according to claim 1, wherein, for the checking, a comparison value of the first and second localization results is observed over a certain time, and a check of the first localization takes place by carrying out a sequential statistical test including a sequential probability ratio test and/or a Kolmogorov-Smirnov test.

7. The method according to claim 1, wherein, for the checking, an uncertainty and/or a confidence regarding positions determined as first and second localization results, is calculated.

8. The method according to claim 7, wherein the uncertainty and/or a confidence is determined by performing a chi-square goodness-of-fit test to statistically test for equality of second Gaussian distributions.

9. The method according to claim 1, wherein the first localization is carried out using data from a global navigation satellite system and/or using an environment model and/or using environment-related information from a vehicle sensor system.

10. A device for localization of a networked motor vehicle, wherein the motor vehicle is configured to be driven in an at least semi-automated manner, wherein the device comprises:
a communication unit; and
at least one computing unit;
wherein the communication unit is configured to receive localization information from an external infrastructure system,
wherein the computing unit is configured to carry out a first localization of the motor vehicle using data from an on-board localization system and to generate first localization results, and to carry out a second localization of the motor vehicle using the received localization information and to generate second localization results, and
wherein the computing unit is further configured to continuously check the first localization via the second localization, using a comparison of the first and second localization results, and to output a result of the check.

11. The device according to claim 10, wherein the device is a control device for the motor vehicle driven in an at least semi-automated manner.

12. A networked motor vehicle which is configured to be driven in an at least semi-automated manner, comprising:
a device for localization of the networked motor vehicle, the device including:
a communication unit; and
at least one computing unit;
wherein the communication unit is configured to receive localization information from an external infrastructure system,
wherein the computing unit is configured to carry out a first localization of the motor vehicle using data from an on-board localization system and to generate first localization results, and to carry out a second localization of the motor vehicle using the received localization information and to generate second localization results, and
wherein the computing unit is further configured to continuously check the first localization via the second localization, using a comparison of the first and second localization results, and to output a result of the check.
